(19) United States
(12) Patent Application Publication
(10) Pub. No.: US 2026/0190196 A1
(43) Pub. Date: Jul. 2, 2026

(54) Lighting Driving Circuit and Control Method, and Lighting System

(71) Applicant: Joulwatt Technology Co., Ltd., Hangzhou (CN)

(72) Inventors: Guoqiang Liu, Hangzhou (CN); Wanyue He, Hangzhou (CN); Yuexia Hu, Hangzhou (CN)

(21) Appl. No.: 19/414,246

(22) Filed: Dec. 9, 2025

(30) Foreign Application Priority Data
Dec. 26, 2024 (CN) 202411947155.6

(51) Int. Cl. H05B 45/50; H05B 45/31; H05B 45/345; H05B 45/37; H05B 47/20

(52) U.S. Cl. CPC H05B 45/50; H05B 45/31; H05B 45/345; H05B 45/37; H05B 47/20

(57) ABSTRACT

The present disclosure provides a control method of a lighting driver circuit, which includes determining generation time and reset time of a capacitive current compensation signal based on an input voltage and a threshold voltage. A compensation signal may be adjusted based on the capacitive current compensation signal. An inductor current of a power stage circuit may be controlled based on the adjusted compensation signal to reduce the phase difference between the input voltage and an input current. Specifically, during an electrical leakage detection stage, electrical leakage is detected when the input voltage exceeds the threshold voltage. The threshold voltage from the electrical leakage detection process is reused to determine the start time and reset time of the capacitive current compensation signal during a lighting driving process. The lighting driver circuit and a light system including the lighting driver circuit are also provided.

### CROSS-REFERENCE TO RELATED APPLICATIONS

This patent application claims priority to China Patent Application No. 202411947155.6, filed on Dec. 26, 2024 and entitled “Lighting driving circuit and control method, and lighting system,” which is hereby incorporated by reference herein as if reproduced in its entirety.

### TECHNICAL FIELD

The present disclosure relates generally to the field of lighting, and in particular embodiments, to a lighting driving circuit and control method, and a lighting system.

### BACKGROUND

FIG. 1 shows a conventional driver circuit of an LED load. Alternating current is rectified by a rectifier bridge to obtain a unidirectional DC input voltage. This input voltage is then filtered by a capacitor C1 and transmitted to a power stage circuit, which converts the input voltage into an output voltage to drive the LED load. However, inevitably, the capacitor C1 introduces a significant phase difference between the input current and the input voltage, thereby reducing the power factor.

To address this issue, existing solutions involve introducing capacitive current compensation during the driving process to reduce the phase difference between the input current and input voltage. However, a challenge with the capacitive current compensation lies in determining the compensation start point and reset point. Existing solutions detect the rate of change of the input voltage dv/dt, and introduce capacitive current compensation when dv/dt is greater than zero. However, determining the compensation start point and reset point by detecting dv/dt increases the amount of external circuitry, leading to increased implementation costs.

### SUMMARY

Technical advantages are generally achieved, by embodiments of this disclosure which describe a lighting driving circuit and control method, and a lighting system.

To address the technical problem of costly implementation for introducing capacitive current compensation in existing technologies, the present disclosure provides a lighting driver circuit and a control method, as well as a lighting system. The control method includes the following steps:
determining a generation time and a reset time of a capacitive current compensation signal based on an input voltage and a threshold voltage; and
adjusting a compensation signal based on the capacitive current compensation signal, and controlling an inductor current of a power stage circuit based on the adjusted compensation signal to reduce a phase difference between the input voltage and an input current;
wherein whether there is electrical leakage is detected in a leakage detection stage when the input voltage is greater than the threshold voltage, the compensation signal is obtained by performing differential operational amplification on a reference signal and an output feedback signal, and the power stage circuit is configured to perform power conversion to drive a load.

Furthermore, a peak envelope curve of the inductor current is controlled to shift to the right based on the adjusted compensation signal.

Furthermore, the capacitive current compensation signal is a sawtooth wave signal, and the capacitive current compensation signal and the compensation signal are superimposed to obtain the adjusted compensation signal.

Furthermore, a moment when the input voltage changes to be greater than the threshold voltage is the generation time, and a moment when the input voltage changes to be less than the threshold voltage is the reset time.

In one embodiment, a voltage at the power input terminal is detected to obtain a sampled voltage, the sampled voltage being a full-wave signal, and a first voltage characterizes the threshold voltage,
when the sampled voltage changes to be greater than the first voltage, the capacitive current compensation signal is controlled to be generated; and when the sampling voltage changes to be less than the first voltage, the capacitive current compensation signal is controlled to be reset.

In another embodiment, a voltage at a power input terminal is detected to obtain a sampled voltage, the sampled voltage being a half-wave signal, and a first voltage characterizes the threshold voltage,
in a first compensation stage, when the sampled voltage changes to be greater than the first voltage, the capacitive current compensation signal is controlled to be generated; and when the sampled voltage changes to be less than the first voltage, the capacitive current compensation signal is controlled to be reset;
in a second compensation phase, a first time and a delay time are acquired, and generation and reset of the capacitive current compensation signal are controlled based on the sampled voltage, the first voltage, the first time, and the delay time,
wherein, in a sampling cycle, the delay time is half of a difference between a duration for which the sampled voltage is greater than the first voltage and a duration for which the sampled voltage is less than the first voltage, and
in the sampling cycle, the first time is the duration for which the sampled voltage is greater than the first voltage.

Furthermore, during the second compensation stage,
the capacitive current compensation signal is generated when the sampled voltage changes to be greater than the first voltage, and thereafter, the capacitive current compensation signal is reset when the sampled voltage changes to be less than the first voltage; and
the capacitive current compensation signal is generated after the delay time has elapsed after the sampled voltage changes to be less than the first voltage, and thereafter, the capacitive current compensation signal is reset after the first time has elapsed after the capacitive current compensation signal is generated.

Furthermore, in an electrical leakage detection stage, electrical leakage current detection is performed when the sampled voltage changes to be greater than the first voltage.

Furthermore, a comparison signal is generated based on the input voltage and the threshold voltage, electrical leakage current detection is performed based on the comparison signal, and generation and reset of the capacitive current compensation signal are controlled based on the comparison signal.

A lighting driver circuit applying the control method described above includes:
an electrical leakage detection circuit detecting whether there is electrical leakage at an input terminal when an input voltage is greater than the threshold voltage during an electrical leakage detection stage;
a power stage circuitry performing power conversion to drive a load; and
a compensation circuit generating a capacitive current compensation signal based on the input voltage and the threshold voltage,
wherein the power stage circuit controls an inductor current based on a superposition signal of the capacitive current compensation signal and a compensation signal.

Furthermore, the lighting driver circuit includes:
a voltage detection unit detecting a power input terminal to obtain a sampled voltage, and generating a first comparison signal based on the sampled voltage and a first voltage characterizing a threshold voltage;
a compensation circuit includes a compensation capacitor, a current source, a reset switch, a detection circuit, and a logic circuit,
the detection circuit outputs a determination signal based on a level state of the first comparison signal, the determination signal indicating whether the sampled voltage is a full-wave signal or a half-wave signal,

when the determination signal indicates the full-wave signal, the logic circuit generates an enable signal and a reset signal according to transition edges of the first comparison signal, the enable signal controlling the current source to charge the compensation capacitor, and the reset signal controlling the reset switch to turn on such that a voltage of the compensation capacitor is cleared to zero.

Furthermore, the compensation circuit also includes: a calculation circuit, a first timing circuit, a second timing circuit, and a comparison circuit, wherein when the determination signal indicates the half-wave signal,
the calculation circuit outputs a delay signal based on durations corresponding to the level state of the first comparison signal, the delay signal representing half of a difference between a duration corresponding to the sampled voltage being greater than the first voltage and a duration corresponding to the sampled voltage being less than the first voltage within a sampling cycle;
the first timing circuit starts timing when the sampled voltage changes to be less than the first voltage according to the first comparison signal, and outputs a first timing signal;
the comparison circuit compares the delay signal with the first timing signal, and outputs a second comparison signal when the first timing signal reaches the delay signal;
the second timing circuit starts timing when the second comparison signal is output, and outputs a second timing signal when a timing duration reaches the first time, the first time representing the duration during which the sampled voltage is greater than the first voltage within the sampling cycle; and
the logic circuit generates the reset signal and the enable signal based on the first comparison signal, the second comparison signal, and the second timing signal.

Furthermore, when the first comparison signal indicates that the sampled voltage is less than the first voltage, the logic circuit generates the enable signal based on the first comparison signal and the second comparison signal, and the logic circuit generates the reset signal based on the first comparison signal and the second timing signal.

Furthermore, when the sampled voltage is within a zero-value range (i.e., the sampled voltage has a zero-value, or the sampled voltage has a value zero (0)), the logic circuit is configured to: generate the enable signal based on the second comparison signal; and generate the reset signal based on the second timing signal.

Furthermore, when the sampled voltage is within a non-zero-value range (i.e., the sampled voltage has a value that is greater than a zero-value or zero (0)), the logic circuit is configured to: generate the enable signal based on the first comparison signal, and generate the reset signal based on the first comparison signal.

A lighting system including the lighting driver circuit described above is also provided.

According to an aspect of the present disclosure, a control method of a lighting driver circuit is provided that includes: determining a generation time and a reset time of a capacitive current compensation signal based on an input voltage and a threshold voltage; and adjusting a compensation signal based on the capacitive current compensation signal, and controlling an inductor current of a power stage circuit based on the adjusted compensation signal to reduce a phase difference between the input voltage and an input current; wherein whether there is electrical leakage is detected in a leakage detection stage when the input voltage is greater than the threshold voltage, the compensation signal is obtained by performing differential operational amplification on a reference signal and an output feedback signal, and the power stage circuit is configured to perform power conversion to drive a load.

According to another aspect of the present disclosure, a lighting driver circuit is provided that includes: an electrical leakage detection circuit configured to detect whether there is electrical leakage at an input terminal during an electrical leakage detection stage when an input voltage is greater than a threshold voltage; a compensation circuit configured to generate and reset a capacitive current compensation signal based on the input voltage and the threshold voltage; and a power stage circuit configured to: perform power conversion to drive a load, and control an inductor current based on a signal that is superposition of the capacitive current compensation signal and a compensation signal to reduce a phase difference between the input voltage and an input current, the compensation signal being obtained by performing differential operational amplification on a reference signal and an output feedback signal.

According to another aspect of the present disclosure, a lighting system comprising the lighting driver circuit described above is also provided.

Embodiments of the present disclosure reuse the threshold voltage from the electrical leakage detection process to determine the start time and the reset time of the capacitive current compensation signal during the driving process. Therefore, in practical implementation, the input voltage detection circuit in the electrical leakage detection circuit can be reused, thereby reducing implementation cost. Simultaneously, the method provided in embodiments of the present disclosure stabilize the start time and the reset time of the capacitive current compensation signal, thereby controlling stable output of the capacitive current compensation signal.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagram of a lighting driver circuit in existing technologies;

FIG. 2 is a graph showing a phase difference between an input voltage and an input current under the control of the lighting driver circuit shown in FIG. 1;

FIG. 3 is a diagram showing waveforms of a capacitive current compensation signal with full-wave sampling according to embodiments of the present disclosure;

FIG. 4 is a diagram showing waveforms of a capacitive current compensation signal with half-wave sampling according to embodiments of the present disclosure;

FIG. 5 is a graph showing a peak envelope curve of an inductor current with a capacitive current compensation signal introduced according to embodiments of the present disclosure;

FIG. 6 is a graph showing a phase difference between an input voltage and an input current with a capacitive current compensation signal introduced according to embodiments of the present disclosure;

FIG. 7 is a structural block diagram of a lighting driver circuit according to embodiments of the present disclosure;

FIG. 8 is a structural block diagram of a compensation circuit according to embodiments of the present disclosure;

FIG. 9 is a diagram of a circuit structure of a compensation circuit according to a first embodiment;

FIG. 10 is a diagram of another circuit structure of a compensation circuit according to a second embodiment; and

FIG. 11 is a diagram of yet another circuit structure of a compensation circuit according to a third embodiment.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Furthermore, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

To facilitate understanding of the present disclosure, a more detailed description will be given below with reference to the accompanying drawings. Some embodiments of the present disclosure are shown in the drawings. However, the present disclosure can be implemented in various forms and is not limited to the embodiments described herein. Rather, these embodiments are provided to provide a thorough and complete understanding of the present disclosure.

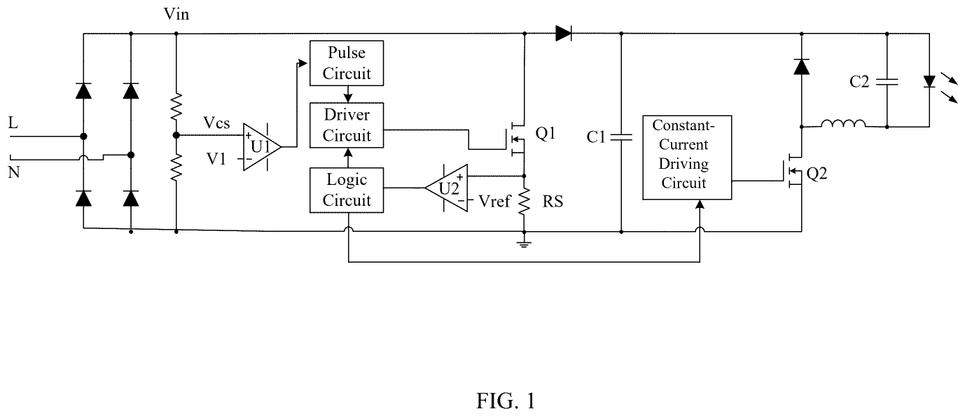

It has been found, from the study and analysis of existing LED lighting systems, that for safety reasons during user installation and removal of LED light tubes, existing LED lighting systems are equipped with an electrical leakage detection circuit to detect whether leakage has occurred at an input terminal. As shown in FIG. 1, the electrical leakage detection circuit typically causes Q1 to conduct when an input voltage is greater than a threshold voltage, to detect the current flowing through Q1, thereby determining whether electrical leakage has occurred.

Based on the above background, the present disclosure proposes that the threshold voltage of the electrical leakage detection stage may be reused to determine the start point and the reset point of introducing capacitive current compensation.

Specifically, embodiments of the present disclosure provide a control method of a lighting driver circuit. The control method includes the following steps:
based on an input voltage and a threshold voltage, determining a moment of generating a capacitive current compensation signal and a moment of resetting the capacitive current compensation signal; and
adjusting a compensation signal according to the capacitive current compensation signal, where a power stage circuit controls an inductor current according to the adjusted compensation signal to reduce the phase difference between the input voltage and an input current; and
where in a leakage detection stage, when the input voltage is greater than the threshold voltage, whether there is electrical leakage at an input terminal is detected, and a differential operational amplification is performed on a reference signal and an output feedback signal to obtain the compensation signal. For example, a differential op-amp may be used to generate the compensation signal based on the reference signal and the output feedback signal.

Furthermore, the moment when the input voltage changes to a value greater than the threshold voltage is the start time of the capacitive current compensation signal, and the moment when the input voltage changes to a value less than the threshold voltage is the reset time of the capacitive current compensation signal. Here, the input voltage is an AC signal, which is rectified by a rectifier bridge to obtain a unidirectional DC signal, the capacitive current compensation signal is a sawtooth wave signal, and the superposition of the capacitive current compensation signal and the compensation signal is the adjusted compensation signal.

Therefore, during each cycle of the input voltage, a capacitive current compensation signal with a gradually increasing amplitude may be introduced when the input voltage is greater than the threshold voltage. The power stage circuit controls the peak value of the inductor current according to the adjusted compensation signal and the sawtooth wave signal, such that the peak envelope curve of the inductor current shifts to the right, thereby reducing the phase difference between the input current and the input voltage.

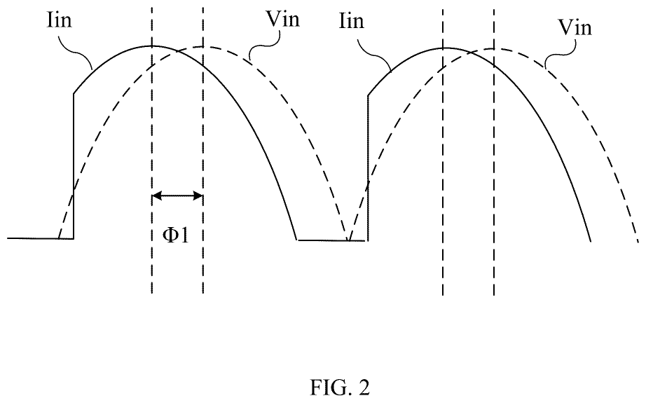

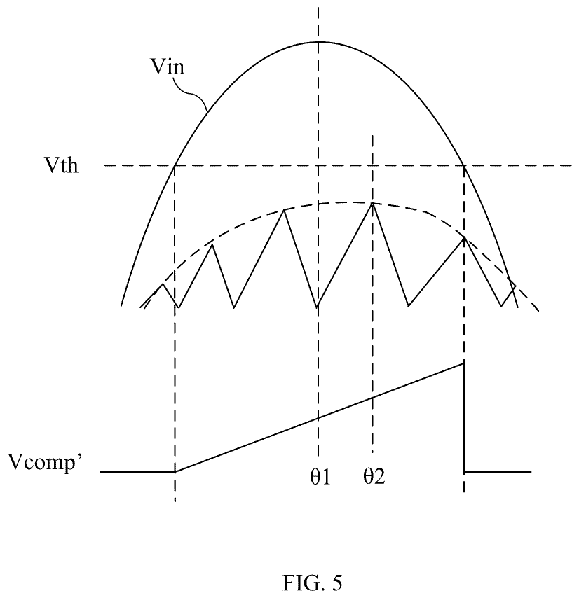

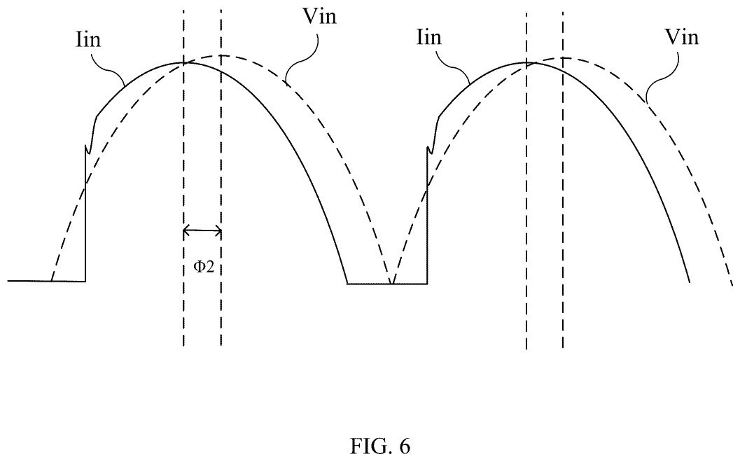

Specifically, as shown in FIG. 5, the phase of the peak point of a peak envelope curve of the inductor current is θ1 when no capacitive current compensation signal is introduced during the lighting driving process. After introducing the capacitive current compensation signal according to embodiments of the present disclosure, the phase of the peak point of the peak envelope curve of the inductor current shifts to the right from θ1 to θ2. It is clear that the peak curve of the inductor current shifts to the right after introducing the capacitive current compensation signal. Therefore, the input current will also shift to the right after introducing the capacitive current compensation signal, reducing the phase difference between the input current and the input voltage. Correspondingly, as shown in FIG. 2, the phase difference between the input current and the input voltage is Φ1 when no capacitive current compensation signal is introduced, and as shown in FIG. 6, the phase difference between the input current and the input voltage is Φ2 with the capacitive current compensation signal introduced. Obviously, Φ1 is greater than Φ2.

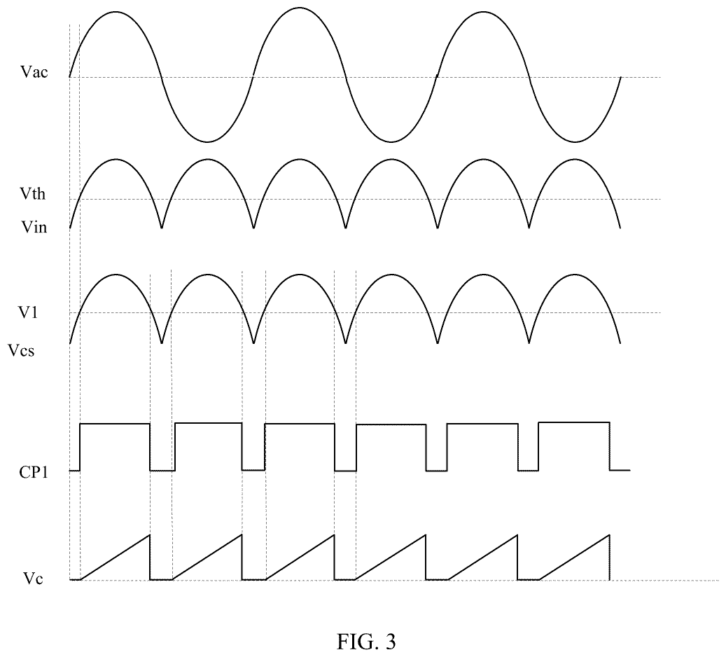

In one embodiment, as shown in FIG. 3, the control method may specifically include the following.

A voltage at a power input terminal is detected to obtain a sampled voltage Vcs. The sampled voltage Vcs is a full-wave signal (the power input terminal may refer to the input terminal of the rectifier bridge or the output terminal of the rectifier bridge), and a first voltage V1 is set to represent the threshold voltage Vth.

A comparison signal is generated by comparing the sampled voltage Vcs with the first voltage V1. When the sampled voltage Vcs changes to be greater than the first voltage V1 based on the comparison signal, a capacitive current compensation signal Vc is generated. When the sampled voltage Vcs changes to be less than the first voltage V1 based on the comparison signal, the capacitive current compensation signal Vc is reset.

Therefore, during full-wave sampling, the generation and reset of the capacitive current compensation signal Vc can be stably and accurately controlled by directly comparing the sampled voltage Vcs and the first voltage V1, so as to stably output the capacitive current compensation signal. This method is simple and easy to implement.

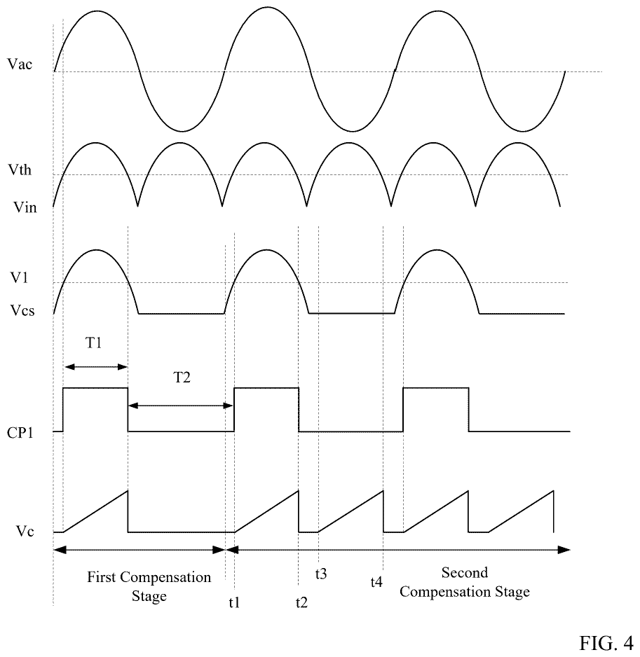

In another embodiment, as shown in FIG. 4, the control method may specifically include the following.

A voltage at a power input terminal is detected to obtain a sampled voltage Vcs (the power input terminal may refer to the input terminal of the rectifier bridge or the output terminal of the rectifier bridge). The sampled voltage Vcs may be a half-wave signal, and a first voltage V1 is set to represent the threshold voltage Vth.

In a first compensation stage, a comparison signal is generated by comparing the sampled voltage Vcs and the first voltage V1. Based on the comparison signal, when the sampled voltage Vcs changes to be greater than the first voltage V1, the capacitive current compensation signal Vc is generated. Based on the comparison signal, when the sampled voltage Vcs changes to be less than the first voltage V1, the capacitive current compensation signal Vc is reset.

In a second compensation stage, a first time and a delay time are acquired, and the generation and reset of the capacitive current compensation signal Vc are controlled based on the sampled voltage Vcs, the first voltage V1, the first time, and the delay time.

Specifically, a comparison signal is generated by comparing the sampled voltage Vcs and the first voltage V1. As shown in FIG. 4, within a complete sampling cycle: when the comparison signal indicates that the sampled voltage Vcs has changed to a value greater than the first voltage V1 at t1, the capacitive current compensation signal Vc is generated; and when the comparison signal indicates that the sampled voltage Vcs has changed to a value less than the first voltage V1 at t2, the capacitive current compensation signal Vc is reset. Thereafter, as the sampled voltage Vcs changes to a zero-value range (i.e., Vcs remains at a constant zero-value (e.g., 0) for a period of time), the level state of the comparison signal remains unchanged, that is, the comparison signal does not show changes of the sampled input voltage. Since there is no state change in the comparison signal, no generation and reset of the capacitive current compensation signal Vc is performed. In this case, in some embodiments, the capacitive current compensation signal Vc may be generated after the delay time has elapsed after the sampled voltage Vcs changes to be less than the first voltage V1. For example, Vc is generated at t3, where the delay time is equal to (t3−t2). The capacitive current compensation signal Vc may then be reset after the delay time and the first time have elapsed after the sampled voltage Vcs changes to be less than the first voltage V1. For example, Vc is reset at t4, where the first time is equal to (t4−t3).

In a sampling cycle, based on durations corresponding to the high level state and the low level state of the comparison signal, two durations may be obtained: a duration T1 corresponding to the sampled voltage Vcs being greater than the first voltage V1 (i.e., Vcs>V1 during T1), and a duration T2 corresponding to the sampled voltage Vcs being less than the first voltage V1 (i.e., Vcs<V1 during T2). The delay time may be set as half of the difference between T1 and T2. That is, delay time=(T1−T2/2 when T1>T2, or delay time=(T2−T1)/2 when T2>T1. During the sampling cycle, based on the durations corresponding to the high and low level states of the comparison signal, a duration during which the sampled voltage Vcs is greater than the first voltage V1 may be taken as the first time. Clearly, when controlling the generation and resetting of the capacitive current compensation signal Vc during the present sampling cycle, the delay signal (delay time) is obtained during the previous sampling cycle, and the first time may be obtained during either the previous or the present sampling cycle, preferably within the present sampling cycle as an example.

As well known, half-wave sampling reduces power consumption compared to full-wave sampling, thereby improving system efficiency. A sampling cycle of the half-wave sampling is equivalent to two adjacent cycles of the input voltage, and the delay time is equal to the duration during which the input voltage is lower than the threshold voltage within an input cycle. Therefore, even with the half-wave sampling, the system may ultimately achieve stable operation through the above control method: outputting a capacitive current compensation signal with a gradually increasing amplitude during a period when the input voltage is greater than the threshold voltage, and resetting the capacitive current compensation signal to zero during a period when the input voltage is smaller than the threshold voltage.

Meanwhile, since interference may occur during transmission, causing distortion of the input voltage, a certain hysteresis may be set when actually setting the first voltage V1 to ensure the stability of the compensation. Therefore, the threshold voltage may be set as being proportional to the first voltage, or the threshold voltage may be set with a certain hysteresis and then proportionally reduced to obtain the first voltage. Both of the approaches are within the protection scope of the present disclosure.

It should be noted that since the sampled voltage obtained by the half-wave sampling is the voltage information of a half cycle of an AC signal, it does not fully represent the actual input voltage. Therefore, in actual control, the first compensation stage is needed for adjustment transition in order to obtain the delay time and the first time during this stage, such that the capacitive current compensation may still be introduced during the period when the sampled voltage lacks input information (information about the sampled voltage is incomplete). It should also be noted that in actual control, the first compensation stage may include only one complete or incomplete sampling cycle, or it may include multiple sampling cycles. If the first compensation stage includes only one incomplete sampling cycle, the delay time obtained in a first sampling cycle of the second compensation stage may be too large (compared with the delay time corresponding to a complete input voltage cycle). In this case, the second compensation stage may also need one sampling cycle for adjustment transition to finally achieve output in a stable state. This adjustment transition process is also a scheme protected by the present disclosure. Both the adjustment transition and the final steady-state adjustment in the control with the half-wave sampling are within the specification of this scheme.

In view of above, the present disclosure reuses the threshold voltage from the electrical leakage current detection process to determine the start time and reset time of the capacitive current compensation signal during the driving process. Therefore, in practical implementation, the input voltage detection circuit in the electrical leakage detection circuit is reused, thereby reducing implementation cost. Simultaneously, the embodiment methods proposed in the present disclosure stabilize the start time and reset time of the capacitive current compensation signal, thereby controlling the stable output of the capacitive current compensation signal.

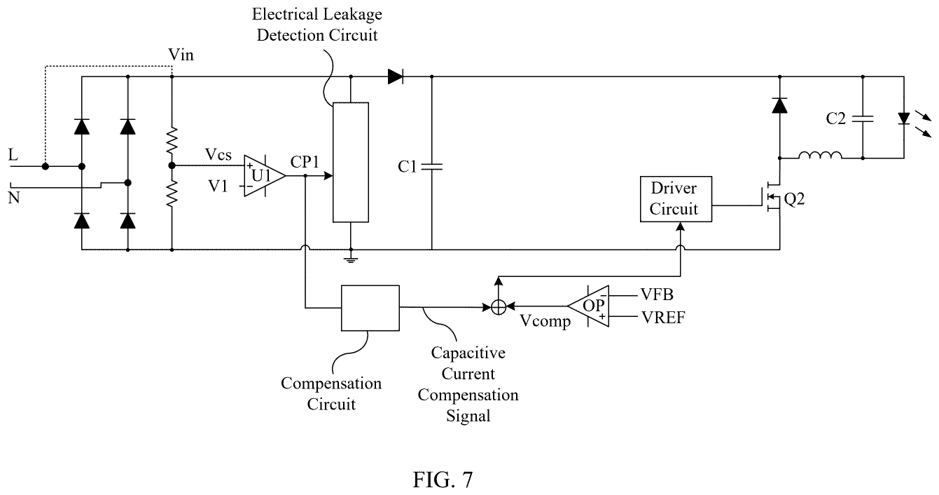

Furthermore, embodiments of the present disclosure also propose a lighting driver circuit that applies the above-mentioned control method, as shown in FIG. 7. The lighting driver circuit includes:
a rectifier bridge configured to perform full-wave rectification of an alternating current (AC) signal to output an input voltage;
an electrical leakage detection circuit configured to detect, during a electrical leakage detection stage, whether there is electrical leakage at an input terminal when the input voltage is greater than a threshold voltage;
a power stage circuit configured to perform power conversion to drive a lighting load;
a compensation circuit configured to generate a capacitive current compensation signal, where the compensation circuit outputs the capacitive current compensation signal when the input voltage is greater than the threshold voltage, and resets the capacitive current compensation signal when the input voltage is less than the threshold voltage.

The power stage circuit is configured to control the peak value of an inductor current based on a superposition signal of the capacitive current compensation signal and a compensation signal, and a sawtooth wave signal, thereby shifting the peak envelope curve of the inductor current to the right and reducing the phase difference between the input voltage and the input current.

In a first embodiment, as shown in FIG. 7, a voltage detection unit is connected to the power input terminal (the power input terminal includes the input terminal of the rectifier bridge and the output terminal of the rectifier bridge), obtains a sampled voltage Vcs, and compares the sampled voltage Vcs with a first voltage V1 that characterizes the threshold voltage Vth to output a first comparison signal CP1. When the first comparison signal CP1 indicates that the sampled voltage Vcs is greater than the first voltage V1, the electrical leakage detection circuit controls Q1 to be turned on according to the first comparison signal CP1, and determines whether there is electrical leakage at the input terminal by detecting the current flowing through Q1. FIG. 7 does not show Q1, and for the positional relationship of Q1, please refer to FIG. 1 for details.

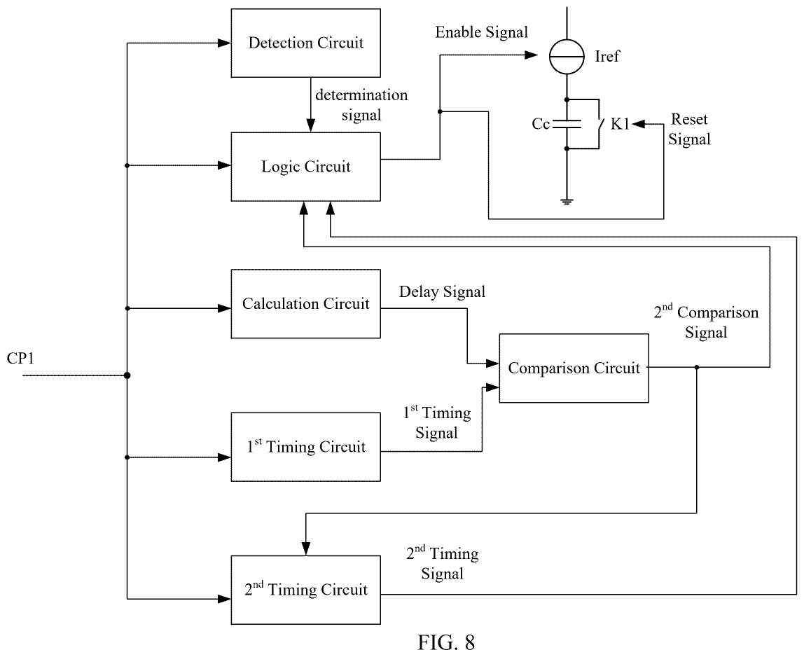

As shown in FIG. 8 as an example, the compensation circuit includes: a compensation capacitor Cc, a constant current source Iref, a reset switch K1, a detection circuit, a calculation circuit, a first timing circuit, a second timing circuit, a comparison circuit, and a logic circuit.

The detection circuit is configured to output a determination signal based on the durations corresponding to the high and low level states of the first comparison signal CP1. The determination signal indicates whether the sampled voltage Vcs is a half-wave signal or a full-wave signal.

The calculation circuit is configured to output a delay signal based on the difference between time corresponding to the high and low level states of the first comparison signal CP1. The delay signal represents half of the difference between a duration when the sampled voltage is greater than the first voltage and a duration when the sampled voltage is less than the first voltage in a sampling cycle.

The first timing circuit starts timing when the sampled voltage Vcs changes to be less than the first voltage V1, based on the first comparison signal CP1, and outputs a first timing signal.

The comparison circuit compares the delay signal and the first timing signal, and outputs a second comparison signal when the first timing signal is greater than or equal to the delay signal.

The second timing circuit receives the second comparison signal and starts timing when the second comparison signal is generated. When a timing duration of the second timing circuit reaches the first time, it outputs a second timing signal. The first time is a duration during which the sampled voltage is greater than the first voltage within a sampling cycle.

When the detection circuit detects that the sampled voltage is a full-wave signal, the logic circuit may be controlled, based on the transition edges of the first comparison signal CP1, to generate an enable signal and a reset signal. Specifically, the rising edge of the first comparison signal CP1 appears when the sampled voltage Vcs changes to be greater than the first voltage V1, and the falling edge of the first comparison signal CP1 appears when the sampled voltage Vcs changes to be less than the first voltage V1. When the rising edge arrives, the logic circuit generates an enable signal, which controls the constant current source Iref to charge the compensation capacitor Cc. When the falling edge arrives, the logic circuit generates the reset signal, which controls the reset switch K1 to turn on such that the voltage of the compensation capacitor Cc is set to zero. The voltage of the compensation capacitor Cc is the capacitive current compensation signal. Therefore, as shown in FIG. 3, the following is achieved: when the input voltage is greater than the threshold voltage, the capacitive current compensation signal starts to be output; during the period when the input voltage is greater than the threshold voltage, the amplitude of the capacitive current compensation signal gradually increases; and when the input voltage is less than the threshold voltage, the capacitive current compensation signal is reset.

When the detection circuit detects that the sampled voltage is a half-wave signal, the logic circuit generates the enable signal based on the first comparison signal CP1, the second comparison signal, and the second timing signal. Specifically, the rising edge of the first comparison signal CP1 appears when the sampled voltage Vcs changes to be greater than the first voltage V1, and the falling edge of the first comparison signal CP1 appears when the sampled voltage Vcs changes to be less than the first voltage V1.

After an initial moment begins, when the rising edge of the first comparison signal CP1 arrives, the logic circuit generates the enable signal, which controls the current source Iref to charge the compensation capacitor Cc. When the falling edge of the first comparison signal CP1 arrives, the logic circuit generates the reset signal, which controls the reset switch K1 to turn on, thus setting the voltage of the compensation capacitor Cc to zero. The voltage of the compensation capacitor Cc is the capacitive current compensation signal. When the rising edge of the first comparison signal CP1 appears again, the logic circuit generates the enable signal, and at this time, the calculation circuit obtains the difference between durations corresponding to the high level state and the low level state of the first comparison signal CP1, thereby outputting the delay signal. Simultaneously, the second timing circuit starts counting up. When the falling edge of the first comparison signal CP1 appears again, the logic circuit generates the reset signal, and at this time, the first timing circuit starts counting to output the first timing signal. At the same time, the second timing circuit stops counting and stores the timing result. The data stored by the second timing circuit is the first time. During the period when the first comparison signal CP1 is at the low level, the first timing signal gradually increases. When the first timing signal increases to the delay signal, the comparison circuit outputs the second comparison signal. At this time, the logic circuit generates the enable signal based on the second comparison signal and the low-level first comparison signal CP1. Simultaneously, when the second comparison signal is generated, the second timing circuit counts down with the stored first time as a reference, and outputs the second timing signal when the timing data returns to zero. At this time, the logic circuit generates the reset signal based on the second timing signal and the low-level first comparison signal.

It should be noted that the operation of the compensation circuit described above with the half-wave sampling employed is based on the sampled voltage at the initial moment being greater than or equal to zero and less than or equal to the first voltage. However, if the sampled voltage at the initial moment is greater than the first voltage, the operation principle of the compensation circuit remains the same as described above, and the only difference is that the delay signal produced by the calculation circuit in the first sampling cycle after the initial moment is relatively large, causing delay in the generation of the capacitive current compensation signal in the second sampling cycle. However, since the transition edges of the first comparison signal control the logic circuit to generate the enable signal and the reset signal, even if the above deviation occurs (the large delay time), the logic circuit may be adjusted, after the second sampling cycle, to be at a stable state where precise control over the generation and reset of the capacitive current compensation signal may be achieved.

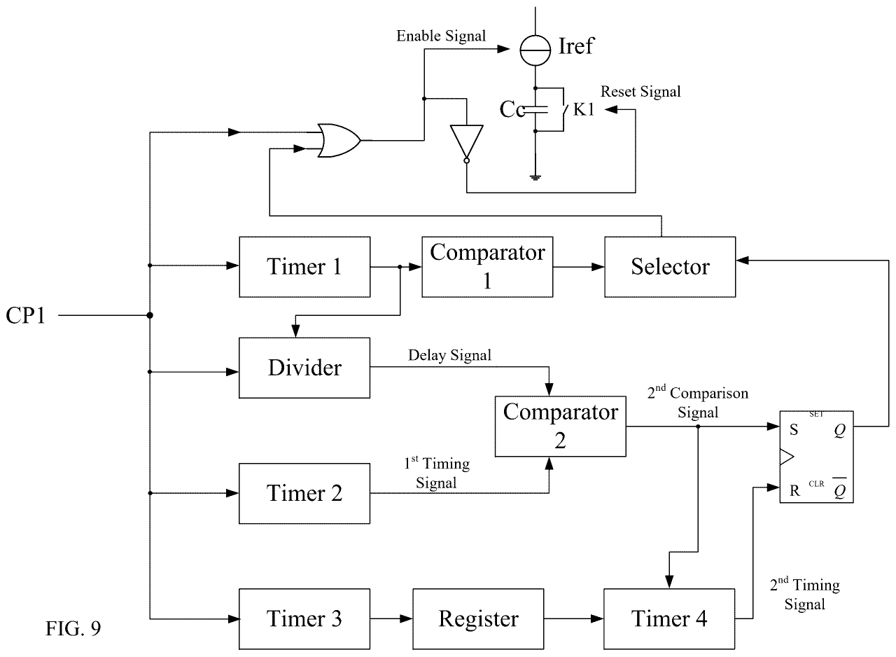

Specifically, as shown in FIG. 9, the detection circuit may be implemented using a timer 1 and a digital comparator 1. The timer 1 counts up during a period corresponding to the high-level state of the first comparison signal CP1 and counts down during a period corresponding to the low-level state of the first comparison signal CP1. The digital comparator 1 determines whether the timing result of the timer 1 is greater than a threshold (the threshold is the difference between a duration during which the input voltage is greater than the threshold voltage and a duration during which the input voltage is less than the threshold voltage, in one cycle). The result of the digital comparator 1 indicates whether the full-wave sampling or the half-wave sampling is used. The calculation circuit may be implemented using the timer 1 and a divider. The first timing circuit may be implemented using a timer 2, which starts timing when the falling edge of the first comparison signal CP1 arrives. The second timing circuit may be implemented using a timer 3, a register, and a timer 4. The timer 3 counts up during the period corresponding to the high-level state of the first comparison signal CP1 and stores the counting result in the register. The register assigns the counting result as an initial value to the timer 4. The timer 4 counts down after receiving the second comparison signal and outputs the second timing signal when it counts to zero. The logic circuit may be implemented using a combination of a selector, a flip-flop, a logic gate, an inverter, and so on, without specific limitations, as long as the functions described above are achieved. Meanwhile, the specific implementation structures of the timer, divider, and comparator mentioned above are existing technologies and will not be elaborated here.

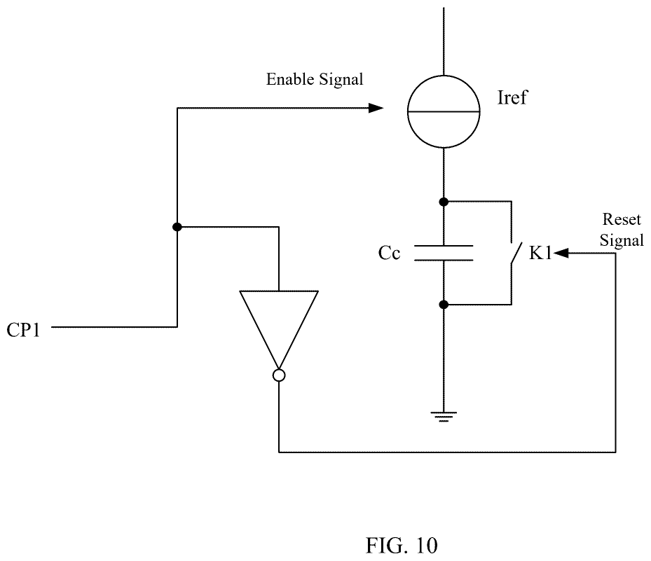

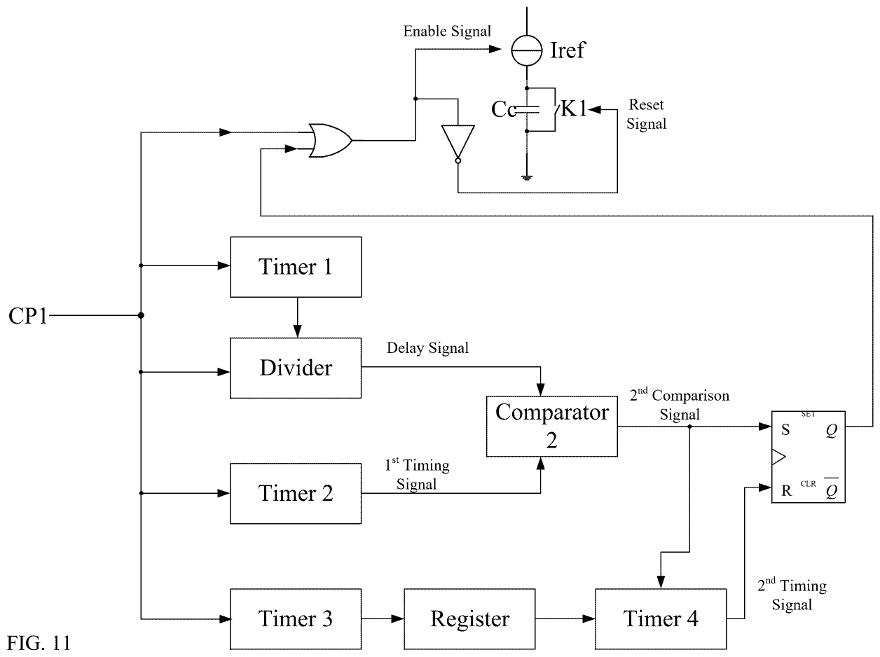

In a second embodiment, when the full-wave sampling is used, some circuit structures in FIG. 9 may be deleted and a compensation circuit as shown in FIG. 10 may be set; and when the half-wave sampling is used, some circuits in FIG. 9 may be deleted and a compensation circuit as shown in FIG. 11 may be set.

The lighting driver circuit and the control method provided above correspond to each other. In addition, the present disclosure also provides a lighting system that uses the lighting driver circuit described above.

It should be noted that the specific implementations and corresponding illustrations provided are merely one way of describing the implementation methods of the present disclosure, and are not intended to limit the specific structures of implementation schemes of the present disclosure. Various changes or modifications can be made to these implementation schemes without departing from the principles and essence of the present disclosure, but all such changes and modifications fall within the protection scope of the present disclosure.

Although the embodiments are described and illustrated separately above, those ordinarily skilled in the art would recognize that common technologies involved may be substituted and integrated them between the embodiments. If there is any content not explicitly described in one embodiment, reference may be made to another embodiment that describes the related content.

The embodiments described above do not constitute a limitation on the protection scope of the technical solutions. Any modifications, equivalent substitutions, and improvements made within the spirit and principle of the above embodiments should be included within the protection scope of the technical solutions.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

What is claimed:

1. A control method of a lighting driver circuit, comprising:
determining a generation time and a reset time of a capacitive current compensation signal based on an input voltage and a threshold voltage; and
adjusting a compensation signal based on the capacitive current compensation signal, and controlling an inductor current of a power stage circuit based on the adjusted compensation signal to reduce a phase difference between the input voltage and an input current;
wherein whether there is electrical leakage is detected in a leakage detection stage when the input voltage is greater than the threshold voltage, the compensation signal is obtained by performing differential operational amplification on a reference signal and an output feedback signal, and the power stage circuit is configured to perform power conversion to drive a load.

2. The control method of claim 1, wherein controlling the inductor current comprises:
controlling, based on the adjusted compensation signal, a peak envelope curve of the inductor current to right-shift.

3. The control method of claim 1, wherein the capacitive current compensation signal is a sawtooth wave signal, and
adjusting the compensation signal comprises superimposing the capacitive current compensation signal and the compensation signal to obtain the adjusted compensation signal.

4. The control method of claim 1, wherein,
a moment when the input voltage changes to be greater than the threshold voltage is the generation time, and
a moment when the input voltage changes to be less than the threshold voltage is the reset time.

5. The control method of claim 4, further comprising:
detecting a voltage at a power input terminal to obtain a sampled voltage, the sampled voltage being a full-wave signal, and obtaining a first voltage characterizing the threshold voltage;
controlling to generate the capacitive current compensation signal when the sampled voltage changes to be greater than the first voltage; and
controlling to reset the capacitive current compensation signal when the sampled voltage changes to be less than the first voltage.

6. The control method of claim 5, further comprising:
performing electrical leakage detection in the leakage detection stage when the sampled voltage changes to be greater than the first voltage.

7. The control method of claim 4, further comprising:
detecting a voltage at a power input terminal to obtain a sampled voltage, the sampled voltage being a half-wave signal, and obtaining a first voltage characterizing the threshold voltage;
in a first compensation stage, controlling to generate the capacitive current compensation signal when the sampled voltage changes to be greater than the first voltage, and controlling to reset the capacitive current compensation signal when the sampled voltage changes to be less than the first voltage;
in a second compensation stage, obtaining a first time and a delay time, and controlling to generate and reset the capacitive current compensation signal based on the sampled voltage, the first voltage, the first time, and the delay time; and
wherein,
the delay time is half of a difference between a duration during which the sampled voltage is greater than the first voltage and a duration during which the sampled voltage is less than the first voltage in a sampling cycle, and
the first time is the duration during which the sampled voltage is greater than the first voltage.

8. The control method of claim 7, wherein, controlling to generate and reset the capacitive current compensation signal in the second compensation stage comprises:
controlling to generate the capacitive current compensation signal when the sampled voltage changes to be greater than the first voltage, and thereafter, controlling to reset the capacitive current compensation signal when the sampled voltage changes to be less than the first voltage; and
after the delay time has elapsed after the sampled voltage changes to be less than the first voltage, controlling to generate the capacitive current compensation signal, and thereafter, controlling to reset the capacitive current compensation signal after the first time has elapsed after the capacitive current compensation signal is generated.

9. The control method of claim 7, further comprising:
performing electrical leakage detection in the leakage detection stage when the sampled voltage changes to be greater than the first voltage.

10. The control method of claim 1, further comprising:
generating a comparison signal based on the input voltage and the threshold voltage;
performing electrical leakage detection based on the comparison signal; and
controlling to generate and reset the capacitive current compensation signal based on the comparison signal.

11. A lighting driver circuit, comprising:
an electrical leakage detection circuit configured to detect whether there is electrical leakage at an input terminal during an electrical leakage detection stage when an input voltage is greater than a threshold voltage;
a compensation circuit configured to generate and reset a capacitive current compensation signal based on the input voltage and the threshold voltage; and
a power stage circuit configured to perform power conversion to drive a load, and control an inductor current based on a signal that is superposition of the capacitive current compensation signal and a compensation signal to reduce a phase difference between the input voltage and an input current,
wherein, the compensation signal is obtained by performing differential operational amplification on a reference signal and an output feedback signal.

12. The lighting driver circuit of claim 11, further comprising:
a voltage detection unit configured to: detect a power input terminal to obtain a sampled voltage, and generate a first comparison signal based on the sampled voltage and a first voltage characterizing the threshold voltage;
wherein the compensation circuit includes a compensation capacitor, a current source, a reset switch, a detection circuit, and a logic circuit;
the detection circuit is configured to output a determination signal based on a level state of the first comparison signal, the determination signal indicating whether the sampled voltage is a full-wave signal or a half-wave signal; and
when the determination signal indicates that the sampled voltage is the full-wave signal, the logic circuit is configured to generate an enable signal and a reset signal based on transition edges of the first comparison signal, the enable signal being configured to control the current source to charge the compensation capacitor, and the reset signal being configured to control the reset switch to turn on to set a voltage of the compensation capacitor to zero.

13. The lighting driver circuit of claim 12, wherein the compensation circuit further comprises: a calculation circuit, a first timing circuit, a second timing circuit, and a comparison circuit, and
when the determination signal indicates that the sampled voltage is the half-wave signal,
the calculation circuit is configured to output a delay signal based on durations corresponding to the level state of the first comparison signal, the delay signal representing half of a difference between a duration during which the sampled voltage is greater than the first voltage and a duration during which the sampled voltage is less than the first voltage in a sampling cycle;
the first timing circuit is configured to start timing when the sampled voltage changes to be less than the first voltage according to the first comparison signal, and output a first timing signal;
the comparison circuit is configured to compare the delay signal with the first timing signal, and output a second comparison signal when the first timing signal reaches the delay signal;
the second timing circuit is configured to start timing when the second comparison signal is output, and output a second timing signal when a timing duration reaches a first time, the first time representing the duration during which the sampled voltage is greater than the first voltage in the sampling cycle; and
the logic circuit is configured to generate the reset signal and the enable signal based on the first comparison signal, the second comparison signal, and the second timing signal.

14. The lighting driver circuit of claim 13, wherein, when the sampled voltage is within a zero-value range, the logic circuit is configured to:
generate the enable signal based on the second comparison signal, and generate the reset signal based on the second timing signal.

15. The lighting driver circuit of claim 13, wherein, when the sampled voltage is within a non-zero-value range, the logic circuit is configured to:
generate the enable signal based on the first comparison signal, and generate the reset signal based on the first comparison signal.

16. A lighting system comprising a lighting driver circuit, the lighting driver circuit comprising:
an electrical leakage detection circuit configured to detect whether there is electrical leakage at an input terminal during an electrical leakage detection stage when an input voltage is greater than a threshold voltage;
a compensation circuit configured to generate and reset a capacitive current compensation signal based on the input voltage and the threshold voltage; and
a power stage circuit configured to: perform power conversion to drive a load, and control an inductor current based on a signal that is superposition of the capacitive current compensation signal and a compensation signal, to reduce a phase difference between the input voltage and an input current,
wherein, the compensation signal is obtained by performing differential operational amplification on a reference signal and an output feedback signal.

17. The lighting system of claim 16, wherein the lighting driver circuit further comprises:
a voltage detection unit configured to: detect a power input terminal to obtain a sampled voltage, and generate a first comparison signal based on the sampled voltage and a first voltage characterizing a threshold voltage;
wherein the compensation circuit includes a compensation capacitor, a current source, a reset switch, a detection circuit, and a logic circuit;
the detection circuit is configured to output a determination signal based on a level state of the first comparison signal, the determination signal indicating whether the sampled voltage is a full-wave signal or a half-wave signal; and
when the determination signal indicates that the sampled voltage is the full-wave signal, the logic circuit is configured to generate an enable signal and a reset signal based on transition edges of the first comparison signal, the enable signal being configured to control the current source to charge the compensation capacitor, and the reset signal being configured to control the reset switch to turn on to set a voltage of the compensation capacitor to zero.

18. The lighting system of claim 17, wherein the compensation circuit further comprises: a calculation circuit, a first timing circuit, a second timing circuit, and a comparison circuit, and
when the determination signal indicates that the sampled voltage is the half-wave signal,
the calculation circuit is configured to output a delay signal based on durations corresponding to the level state of the first comparison signal, the delay signal representing half of a difference between a duration during which the sampled voltage is greater than the first voltage and a duration during which the sampled voltage is less than the first voltage in a sampling cycle;
the first timing circuit is configured to start timing when the sampled voltage changes to be less than the first voltage according to the first comparison signal, and output a first timing signal;
the comparison circuit is configured to compare the delay signal with the first timing signal, and output a second comparison signal when the first timing signal reaches the delay signal;
the second timing circuit is configured to start timing when the second comparison signal is output, and output a second timing signal when a timing duration reaches a first time, the first time representing the duration during which the sampled voltage is greater than the first voltage in the sampling cycle; and
the logic circuit is configured to generate the reset signal and the enable signal based on the first comparison signal, the second comparison signal, and the second timing signal.

19. The lighting system of claim 18, wherein, when the sampled voltage is within a zero-value range, the logic circuit is configured to generate the enable signal based on the second comparison signal, and generate the reset signal based on the second timing signal;
when the sampled voltage is within a non-zero-value range, the logic circuit is configured to generate the enable signal based on the first comparison signal, and generate the reset signal based on the first comparison signal.

20. The lighting system of claim 17, wherein a voltage of the compensation capacitor is the capacitive current compensation signal.
